(19) United States
(12) Patent Application Publication
(10) Pub. No.: US 2013/0073171 A1
(43) Pub. Date: Mar. 21, 2013

(54) METHOD AND DEVICE FOR DETECTION OF CONTAMINATION BY FUEL OF THE OIL CIRCUIT OF A TURBINE

(71) Applicants: Jean-Louis Muller, Alfortville (FR); François Demaison, Nandy (FR); Nicolas Potel, Maisons Alfort (FR)

(72) Inventors: Jean-Louis Muller, Alfortville (FR); François Demaison, Nandy (FR); Nicolas Potel, Maisons Alfort (FR)

(73) Assignee: SNECMA, Paris (FR)

(21) Appl. No.: 13/617,499

(22) Filed: Sep. 14, 2012

(30) Foreign Application Priority Data
Sep. 20, 2011 (FR) 11 58347

(51) Int. Cl. B64D 45/00

(52) U.S. Cl. 701/100

(57) ABSTRACT

A method for detection of contamination, by another fluid, of the oil circuit of a turbomachine fitted on an aircraft, the oil circuit including a tank provided with a device for measuring its oil level, piping which connects the tank to the various units of the turbomachine to be lubricated, and a device for putting the oil into circulation between the tank and the units, the turbomachine including a device for measuring its engine speed and a device for measuring the temperature of the oil at one point at least of the oil circuit. The oil level in the tank is monitored, an alert is triggered if the decrease in the oil level, measured over a given interval of time, becomes lower than a set minimum decrease. The decrease can be replaced by a simple increase in the oil level, without taking a duration of the monitoring into account.

### BACKGROUND OF THE INVENTION

The field of the present invention is that of turbomachines, and more particularly that of lubrication of these turbomachines.

From upstream towards downstream in the direction of the flow of the gases, a turbomachine for an aircraft generally comprises a fan, one or a plurality of compressor stages, for example a low-pressure compressor and a high-pressure compressor, a combustion chamber, one or a plurality of turbine stages, for example a high-pressure turbine and a low-pressure turbine, and a gas exhaust pipe. A turbine can correspond to each compressor, the two being connected by means of a shaft, thus forming for example a high-pressure core and a low-pressure core. The turbomachine generally has firstly, substantially at the level of the upstream end of the high-pressure core, an “upstream chamber”, and secondly, substantially at the level of the downstream end of the high-pressure core, a “downstream chamber”, these two chambers containing units of the bearing and gear type. These chambers are bathed in an atmosphere containing oil for the lubrication of the different units.

In addition, a flow of gas passes through these chambers, in particular for ventilation purposes. In order to prevent oil from being transported outside the chambers by the flow of gas, the ventilation gases are discharged via “oil extractors”, and are ejected via a so-called degassing tube, generally at the level of the turbine pipe.

Since the function of the oil is to lubricate the chambers, but also to discharge the calories contained in them, one or a plurality of heat exchangers are installed on the turbomachines. These exchangers are commonly of the oil—fuel type, the oil then being cooled by the fuel which is stored in the tanks of the aircraft, and is at a relatively low temperature. For reasons of minimization of their weight, but also optimization of the thermal transfer, these exchangers have particularly thin walls. If a breach were to appear in one of these thin walls, taking into account the differences in the pressure level of the two fluids, fuel could contaminate the oil and pass into the circulation circuit of the oil. Because of the temperature which exists in this circuit, the fuel will then vaporize rapidly, and will give rise to a significant increase in the pressure in the piping, with possible risks of excess pressure in the oil tank, which could lead to rupture of the tank. A fire could also start in the ventilation circuit.

### DESCRIPTION OF THE PRIOR ART

Various solutions have been devised in order to solve the problem of the risk of contamination of the oil by fuel.

A first solution would consist of ensuring that under no circumstances could the fuel flow into the oil circuit. For this purpose it would be necessary to modify the architecture of the oil/fuel systems so that the oil pressure in the exchangers is greater than that of the fuel. Thus, it is the oil which would contaminate the fuel, and the mixture produced would then be burned in the combustion chamber. This solution would also have the advantage that the contamination is easy to detect by means of the perception of a smell of burnt oil during the refueling between two flights. However, this detection can be assured only during refueling operations, i.e. at intervals which may be as much as several hours. But above all, this solution involves positioning the exchangers in specific locations, where the oil pressure is highest and the fuel pressure is lowest. This arrangement may not be an optimal solution though from the thermal point of view for the regulation systems. The weight of the exchangers, their efficiency and their size may then be excessive, and the resulting position constraint would consequently prevent improvement of the engine performance. A second solution consists of taking into account the consequences of contamination of the oil by the fuel in the dimensions of the oil system equipment. The tank must then withstand over-filling and the associated excess pressure, and in addition “fire-protection” grids must be placed in various locations in order to prevent any flames from rising into the engine by means of the ventilation tube. This second solution has a direct impact on the equipment, by making it necessary to increase its robustness, and therefore its size and weight. Finally, despite the arrangement of fire-protection grids, the risk of fire at the exit from the ventilation tube is always present, and can lead to deterioration of the engine.

### SUMMARY OF THE INVENTION

The objective of the present invention is to eliminate these disadvantages by proposing a method and a device for protection against the risks associated with contamination by fuel of the oil circuit of a turbomachine, which assures continual monitoring and makes possible a reduction of weight for the equipment concerned.

For this purpose, the object of the invention is a method for detection of contamination, by another fluid, of the oil circuit of a turbomachine fitted on an aircraft, said oil circuit comprising at least one tank provided with a means for measurement of its oil level, piping which connects said tank to the various units of the turbomachine to be lubricated, and at least one means for putting the oil into circulation between said tank and said units, said turbomachine comprising a means for measurement of its engine speed and a means for measurement of the temperature of the oil at one point at least of said oil circuit. It is characterized in that it comprises monitoring of the oil level in the tank, which is associated with the triggering of an alert if the decrease in said oil level, measured over a given interval of time, becomes lower than a set minimum decrease.

Apart from during deceleration of the engine or an increase in its temperature, the detection of an increase, or an abnormally low decrease in the level of oil in the tank indicates that contamination of the oil circuit has taken place, and that a fluid, probably fuel, has penetrated into this circuit.

Preferably, triggering of the alert is inhibited if deceleration of the engine speed of the turbomachine takes place during said interval of time.

Also preferably, the triggering of the alert is inhibited if an increase in the temperature of the oil in the tank takes place during said interval of time.

These two alternative solutions make it possible to implement the method throughout the duration of the flight of the aircraft, and not to limit the duration solely to the phases of stabilized cruising.

According to a preferred embodiment, the set decrease is replaced by a positive or zero increase in any interval of time. This solution makes it possible to simplify the method, by taking into account only an increase in the volume of oil in the tank, and not taking into account the time which has elapsed during the monitoring.

The invention also relates to a computer which is designed to be fitted on a turbomachine, comprising an input which can be connected to a sensor which indicates the level of the oil in a tank of said turbomachine, and a means for calculation of the development of the oil level over a given interval of time, wherein it provides an alert of contamination of the oil by another fluid, if the decrease measured of the oil level in said tank over said interval of time becomes lower than a set minimum decrease.

Preferably, the computer additionally comprises an input which can receive data relating to the engine speed of said turbomachine, and it inhibits the triggering of the alert if a deceleration of the engine speed of the turbomachine takes place during said interval of time.

Also preferably, the computer additionally comprises an input which can receive data relating to the temperature of the oil at a point of said circuit, and it inhibits the triggering of the alert if an increase in the temperature of the oil in the tank takes place during said interval of time.

In a simplified version, the computer comprises an input which can receive data relating to the start and end of cruising of an aircraft on which said turbomachine is installed, and it inhibits the triggering of the alert outside said cruising phase.

Finally, the invention relates to a turbomachine which is designed to be fitted on an aircraft and on said aircraft, one or the other comprising a computer as previously described, for the detection of contamination on the oil circuit of the turbomachine.

### DESCRIPTION OF THE DRAWINGS

The invention will be better understood, and other objectives, details, characteristics and advantages of it will become more apparent, during the following detailed explanatory description of an embodiment of the invention given purely by way of illustrative and non-limiting example, with reference to the attached schematic drawings.

In these drawings:

FIG. 1 is a general view of the oil circuit of a turbomachine;

FIG. 2 is a schematic view of the oil consumption by a turbine during a flight on an aircraft; and

FIG. 3 is a diagram describing the steps to be followed in order to assure the detection of contamination, according to an embodiment of the invention.

### DESCRIPTION OF THE PREFERRED EMBODIMENTS

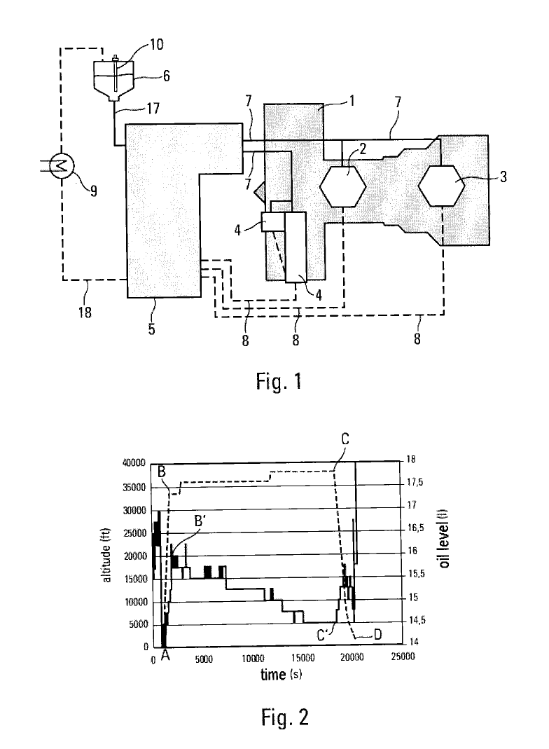

FIG. 1 shows the lubrication circuit of the chambers and gearboxes of a turbomachine 1. The latter comprises two chambers, i.e. an upstream chamber 2 and a downstream chamber 3, which contain bearings and gears associated with the rotation shafts of the turbomachine. It also comprises gearboxes 4 (two of which are represented), which are used in order to assure driving of the accessories by the turbomachine. In order to assure the lubrication of these chambers and gearboxes, the turbomachine bears a lubrication unit 5, which, by means of pumps and valves, assures the control of the circulation of the oil between the main oil tank 6 and the different units, by means of supply piping 7 and recuperation piping 8. The unit 5 collects oil from the tank 6 via feeding piping 17, and conveys it via the supply piping 7 to the different units. The oil is recuperated in the low part of these chambers and accessory housings by the recuperation piping 8, which supplies it to the lubrication unit 5, from where it is returned by return piping 18 to the tank 6. On the path of the return piping 18, the oil passes through one or a plurality of heat exchangers 9, where it transfers its calories to fuel obtained from the fuel tanks of the aircraft. It is for the protection of this exchanger that the present invention has been created.

The oil tank 6 comprises a sensor 10 which is plunged into the oil, and, by means of a gauging device (not represented) makes it possible to determine continually the level of the oil which is in this tank.

FIG. 2 represents the development of two parameters during a flight of the aircraft on which the turbomachine 1 is installed. The curve in a broken line shows the development, according to time, of the altitude of the aircraft, after take-off, represented by the point A, and until landing, which corresponds to the point D. The flight is characterized firstly by rising (segment A-B) to the cruising altitude, then by a rising cruising phase (segment B-C), with the altitude developing from 34000 to 36000 then to 38000 feet as a result of the progressive lightening of the aircraft, and finally by a phase of descent and landing (segment C-D).

In parallel, the level of the oil in the tank 6 develops according to the curve in solid lines. Throughout the travel on the ground and the take-off, corresponding to the time which elapses between the origin and the abscissa of point A, the level of the oil develops strongly, because of the developments of the engine speed of the turbomachine. At the moment when the cruising altitude and reduction of the engine speed are obtained, the oil level settles at the level of point B′, i.e. at approximately 16 liters. With the engine speed remaining settled throughout the cruising (except for during the two very short phases of change of level of flight), the oil level develops very slowly between the point B′ and a point C′ of end of cruising. The level in the tank 6 thus goes from 16 to 14.5 liters, simply as a result of the consumption of oil by the engine. Finally, during the phase of descent and landing, the engine speed develops once more, which generates erratic developments of the oil level in the tank 6.

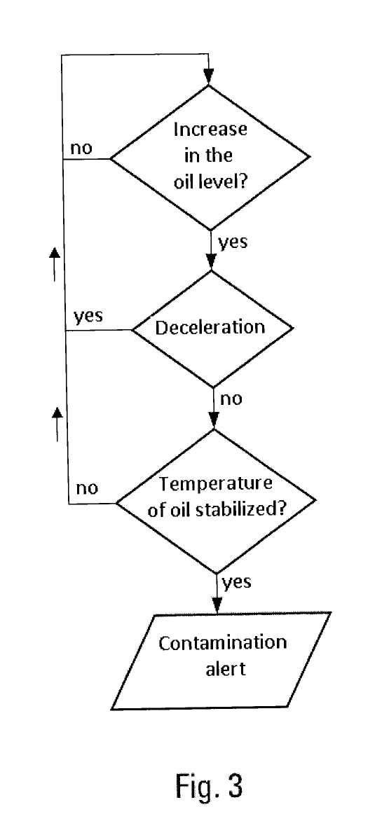

FIG. 3 shows the decision diagram according to the invention, leading to the triggering of an alert further to contamination of the oil circuit by fuel. An alert of this type makes it possible to warn the aircraft pilot of a danger associated with incorrect functioning of the turbomachine, and to inform him that he must carry out a particular action, as is defined a priori in his flight manual. The alert triggering logic comprises the following steps:
continual analysis of the level of oil in the tank;
detection of any increase in this level of oil?;
if the answer is positive, is this associated with a deceleration of the engine speed?;
if the answer is negative, has the temperature of the oil remained stable?;
if the answer is positive, triggering of the alert;
in all the other cases there is no triggering of the alert, and the device is returned to the initial conditions, i.e. of monitoring of any increase in the level of oil.

A description will now be provided of the functioning of the device for detection of contamination, according to the invention.

The concept on which the invention is based consists of using the oil measurement which already exists in order to detect contamination of the oil.

At a stabilized speed, which is the case in particular when an airliner is cruising, the volume of the oil which is present in the tank 6 varies only under the effect of its consumption by the engine. The typical consumption of a modern engine is a few deciliters per hour, whereas the precision of measurement given by the sensor 10 and its measurement chain is generally approximately half a liter. Thus, for scales of time which are less than an hour, at a stabilized speed, the volume of the oil can be considered to be constant.

Consequently it can be deduced that when cruising, an increase in the oil level corresponds to contamination of the oil by fuel, or by any other fluid with which the oil could be put into contact.

Reading of FIG. 2 shows that, on the basis of a curve which is representative of tests on an engine during flight:
the oil level during the stabilized cruising phase decreases slightly over a period of time, i.e. with a typical decrease of level of 1 liter in 3 hours;
substantial variations of the oil level are observed during the transitory phases, which are associated with the variations of the engine speed during these transitory phases; and
oscillations are also observed, which are due to the technology of the sensor 10 for measurement of the volume of oil and its measurement chain, and which correspond to oscillations of the surface of the oil in the tank 6.

However, detection of contamination based only on an increase in the oil level would not be perfect, since this level varies according to the engine speed, and also develops according to its temperature. In fact, when the engine is in full throttle, oil is trapped in the engine in a larger quantity than when the engine is idling. Because of this phenomenon, which is also called “gulping” by persons skilled in the art, an oil tank can fill simply as a result of the effect of a reduction in the speed of rotation of the engine. On the other hand, during strong acceleration, when taking off for example, the volume of oil can drop as a result of the gulping, but it can also rise by itself under the effect of the thermal expansion, since the oil heats up during an acceleration.

The detection must therefore take into account the behavior of the engine, such that the monitoring is extended to the transitory phases. For this purpose, the associated device must be coupled to the engine speed sensor and to the oil temperature sensor, if it is wished to use the device throughout all of the flight.

Finally, the detection logic selected for the invention, which functions both in transitory conditions and at a stabilized speed, is that described in FIG. 3:
if an increase in the oil level is detected, the alert device examines whether this increase is coupled with a deceleration of the speed; if this is the case, the alert is inhibited, and the device returns to its function of detection of an increase in the oil level;
if this is not the case, the alert device analyses the temperature of the oil in order to determine whether this varies:
if this is the case, the device considers that the oil level is developing for reasons of thermal origin, and the alert is inhibited;
if this is not the case, the alert is triggered, and the pilot, or an expert system, is warned that there is an abnormality which must be dealt with.

According to an improved variant of the invention, it can be envisaged to extend the triggering of the alert to the case of an abnormally slow decrease in the oil level in the tank, without an increase in this level formally existing. Since the nominal consumption of oil is known, it is possible to replace the detection of an increase in the level by that of a decrease which is lower than a set decrease; this set decrease is selected such as to be equal, with margins, to the nominal decrease. If the decrease of level observed is too slight, this means that a foreign fluid has been introduced into the oil circuit, and therefore contamination has taken place, with the risks that this involves. In this case the monitoring must be assured during pre-established observation times, at the end of which the measurement of reduction of the level is calculated. Periodic resumption of the monitoring must also be put into place. For their part, the inhibitions of the alert are applied if, as in the previous case, either a reduction of the speed or an increase in the temperature of the oil takes place during the interval of time concerned.

Finally, simplified versions of the invention can be implemented, with monitoring which is assured only during the cruising phase, with prevention of possible triggering of a contamination alert during the phases of take-off and rising, or descent and landing. The device is then put into operation or out of service by means of an action by the pilot or an expert system, indicating that cruising has begun or has ended.

The advantages which are provided by the invention can be summarized as follows:

The monitoring which is carried out continually makes it possible to limit the running time of the engine in the case of contamination by fuel. The safety of running is therefore reinforced, and the risks of problems which are associated with fire are greatly reduced.

Putting this monitoring into place does not lead to any penalty in terms of cost, weight, or difficulty in installation of the equipment, since it uses sensors which are already present for other functions in the oil circuit. In addition, this monitoring has no impact on the part these sensors play in their main tasks.

Finally, putting this monitoring into place makes it possible to relax the specifications which are imposed on the oil circuit equipment in terms of pressure levels which they must be able to withstand. For example, the internal pressure could triple in the case of contamination by fuel. Early detection by a device according to the invention makes it possible not to take this constraint of possible excess pressure into account in the design of the equipment. The strength of the equipment can therefore be reduced, and the same applies to its weight and cost.

The method described by the invention is designed to be implemented on a turbomachine, whilst being implanted in a computer housing which is implanted either directly on the turbomachine or on the aircraft which the turbomachine propels. The present invention consequently relates to any housing or any type of physical support which carries out the calculations associated with the implementation of this method.

1. A method for detection of contamination, by another fluid, of the oil circuit of a turbomachine fitted on an aircraft, said oil circuit comprising at least one tank provided with a means for measurement of its oil level, piping which connects said tank to the various units of the turbomachine to be lubricated, and at least one means for putting the oil into circulation between said tank and said units, said turbomachine comprising a means for measurement of its engine speed and a means for measurement of the temperature of the oil at one point at least of said oil circuit,
wherein said method comprises monitoring of the oil level in the tank, which is associated with the triggering of an alert if the decrease in said oil level, measured over a given interval of time, becomes lower than a set minimum decrease.

2. The method as claimed in claim 1, wherein triggering of the alert is inhibited if deceleration of the engine speed of the turbomachine takes place during said interval of time.

3. The method as claimed in claim 1, wherein the triggering of the alert is inhibited if an increase in the temperature of the oil in the tank takes place during said interval of time.

4. The method as claimed in claim 1, wherein the set decrease is replaced by a positive or zero increase in any interval of time.

5. A computer which is designed to be fitted on a turbomachine, comprising an input which can be connected to a sensor which indicates the level of the oil in a tank of said turbomachine, and a means for calculation of the development of the oil level over a given interval of time,
wherein said computer provides an alert of contamination of the oil by another fluid, if the decrease measured of the oil level in said tank over said interval of time becomes lower than a set minimum decrease.

6. The computer as claimed in claim 5, wherein said computer additionally comprises an input which can receive data relating to the engine speed of said turbomachine, and wherein said computer inhibits the triggering of the alert if a deceleration of the engine speed of the turbomachine takes place during said interval of time.

7. The computer as claimed in claim 5, wherein said computer additionally comprises an input which can receive data relating to the temperature of the oil at a point of said circuit, and wherein said computer inhibits the triggering of the alert if an increase in the temperature of the oil in the tank takes place during said interval of time.

8. The computer as claimed in claim 5, wherein said computer comprises an input which can receive data relating to the start and end of cruising of an aircraft on which said turbomachine is installed, and wherein said computer inhibits the triggering of the alert outside said cruising phase.

9. A turbomachine which is designed to be fitted on an aircraft, wherein said computer comprises a computer as claimed in claim 5.

10. An aircraft, wherein said computer comprises a computer as claimed in claim 5, for the detection of contamination on the oil circuit of at least one of its turbomachines.
